(19) United States
(12) Patent Application Publication
(10) Pub. No.: US 2026/0317041 A1
(43) Pub. Date: Oct. 15, 2026

(54) Transport Container

(71) Applicant: R & V Aqualine Industries Pty Ltd, Carboor (AU)

(72) Inventors: Robin Box, Carboor (AU); Andrew Berry, Carboor (AU)

(21) Appl. No.: 19/485,251

(22) PCT Filed: May 17, 2024
(86) PCT No.: PCT/AU2024/050502

§ 371 Date: Nov. 17, 2025

(30) Foreign Application Priority Data
May 17, 2023 (AU) 2023901516

(51) Int. Cl. B65D 81/38; B65D 81/127

(52) U.S. Cl. CPC B65D 81/3825; B65D 81/127; B65D 81/3813

(57) ABSTRACT

A transport container for a cryogenic vessel, comprising a lower member and two upper members that are attached thereto, the lower and upper members together defining a cavity for accommodating the vessel therein, with the upper members being moveable between an open position and a closed position, wherein, in the closed position, the upper members cooperate to form a lid that interlocks with the lower member to close the cavity.

### TECHNICAL FIELD

The invention relates to a transport container, in particular to a container for transporting a cryogenic vessel.

### BACKGROUND

Cryogenic vessels are used in the storage of biological matter. Such vessels are typically provided in the form of a metallic storage tank—also referred to as a “dewar”—and rely on the use of a cryogenic fluid (for example, liquid nitrogen and liquid hydrogen) contained therein to provide a stable, low temperature environment within which the biological matter can be held for prolonged periods.

The storage of biological matter within such cryogenic vessels is commonplace across several industries, and particularly widespread within medical and veterinarian fields. For example, with respect to artificial insemination (“AI”) of animals such as cattle, horses and dogs, it is known to extract semen from a male animal before depositing the semen within the uterus of a female animal. Typically, this AI process take place over a period of several months—at times years—and thus it is necessary to store the biological matter cryogenically to ensure that the sample remains viable.

Breeders within the animal AI industry are increasing looking to transport such stored biological matter between locations, including internationally. To ensure integrity of the cryogenic vessel and the biological matter stored therein, cryogenic vessels containing semen are typically installed within an outer casing before vehicular transportation. Examples of existing casings typically comprise plastic barrels that topped with a removeable lid, with the lid sealed in position atop the barrel via an external clamp arrangement, with a separate handle being fixed in place onto the barrel body.

Existing casings are not without their drawbacks. In particular, such casings provide limited physical protection to the cryogenic vessel during transport, often serving as little more than a barrier that prevents direct contact of the cryogenic vessel with other cargo during transport. Further, clamps used to secure the lid atop the barrel are vulnerable to damage during handling and transport, which may result in the lid being dislodged and the vessel therein being exposed. Moreover, existing casings can be expensive to ship and to manufacture.

Within this context, there is a need for an improved cryogenic transport casing or to at least provide the public with a useful choice. The present invention was conceived with these shortcomings in mind.

### SUMMARY

In a first aspect, the invention provides a transport container for a cryogenic vessel, comprising a lower member and two upper members that are attached thereto, the lower and upper members together defining a cavity for accommodating the vessel therein, with the upper members being moveable between an open position and a closed position, wherein, in the closed position, the upper members cooperate to form a lid that interlocks with the lower member to close the cavity.

In a second aspect, the invention provides a method of fabricating the container as described herein, comprising the steps of: forming each of the lower and upper members via a moulding process; and attaching each upper member to the lower member by a pin that is insertable through hinge elements of the respective upper member and the lower member.

The lower member and each upper member may engagement elements that, when the upper members are in the closed position, form an internal detent that secures the upper members in the closed position. The engagement element of the lower member may comprise a projection that is configured to seat within a slot of each of the upper members in a snap-fit.

In some embodiments, the upper members include cooperating elements that guide and locate the upper members into the closed position. When the upper members are in the closed position, the cooperating elements may form a barrier that extends across an opening of the cavity and directs water away therefrom. The cooperating elements may comprise a lip that projects from an inner surface of a first of the upper members and a trough within an inner surface of a second of the upper members, with the lip being receivable within the trough.

In the closed position, the upper members may together form a carry handle of the container. When the container is carried by the handle, the upper members may be biased towards the closed position. Each upper member may include an upwardly extending handle portion for moving the upper members between the open and closed positions, the handle portions abutting in the closed position of the upper members to form the carry handle.

In some embodiments, each handle portion may include a hole for receiving an anti-tampering member therethrough to prevent unauthorised and/or inadvertent movement of the upper members from the closed position, the hole being spaced from a grip portion of the handle.

The upper members may be hingedly attached to the lower member, with the upper members and the lower member having integrated hinge elements. The lower member may have a tapered profile, with the hinge elements being disposed within a footprint thereof. The hinge elements may be flush or recessed with respect to outer surfaces of the upper members and the lower member, so as not to protrude outwardly therefrom. The hinge elements of the lower member may be receivable between the hinge elements of the upper member, with each hinge element being configured to receive a pin.

In some embodiments, an outer surface of the lower member may be adapted to allow a plurality of containers to be arranged together in a nested arrangement. The outer surface of the lower member may be adapted such that, in the nested arrangement, a plurality of defined gaps are formed between abutting containers. The outer surface of the lower member may comprise a plurality of substantially planar faces arranged around a vertical perimeter thereof, with the plurality of gaps between abutting containers being defined by fillets disposed between adjacent faces of the respective containers. At least one of the faces of the lower member may include a high friction surface.

The container may further comprise insulating members mounted within the cavity to protect the vessel therein. The insulating members may be removably insertable into grooves within the lower member, with the insulating members being selected to suit the size and/or shape of the vessel. Alternatively or additionally, each upper member may include a seat for receiving one of the insulating members.

In some embodiments, the lower member and each upper member may be formed, respectively, as a unitary body. The lower member and each upper member may be formed of a polymeric material.

In some embodiments, the container may include a pair of pick-up portions that are disposed disposed on opposite sides of the container. Each pick-up portion may be disposed on a respective upper member of the container. Each pick-up portion may be in the form of a notch.

In a further aspect, the invention provides a transport container for a cryogenic vessel, comprising a lower member and two upper members that are attached thereto, the lower and upper members together defining a cavity for accommodating the vessel therein, with the upper members being moveable between an open position and a closed position, wherein, in the closed position, the upper members cooperate to form a lid that interlocks with the lower member to close the cavity and form a carry handle.

In a further aspect, the invention provides a transport container for a cryogenic vessel, comprising a lower member and two upper members that are attached thereto, with the upper members being moveable between an open position for receiving the vessel through an opening of the lower member and a closed position in which the upper members form a lid over the opening, wherein, in the closed position, the upper members form a carry handle, with the upper members being biased towards the closed position when the container is carried by the handle.

### BRIEF DESCRIPTION OF THE DRAWINGS

The invention will now be described, by way of non-limiting example only, with reference to the accompanying drawings, in which:

FIG. 1 is an exploded view a container for a cryogenic vessel according to a first embodiment of the invention, showing a lower member of the container and two upper members that are attachable thereto;

FIG. 2 is a perspective view of the container of FIG. 1, showing the container in a first or open configuration, with the vessel being receivable through an opening of the lower member;

FIGS. 3 to 7 show the container of FIG. 1 in a second or closed configuration, with the upper members cooperating to form a lid that covers the opening;

FIG. 8 is an inside view of a first upper member of the container of FIG. 1, showing a lip that projects from an inner surface thereof;

FIG. 9 is an inside view of a second upper member of the container of FIG. 1, showing a trough within an inner surface thereof that is adapted to cooperate with the lip of the first upper member;

FIGS. 10 and 11 show a container for a cryogenic vessel according to another embodiment of the invention; and

FIG. 12 is a flowchart schematically illustrating a method of fabricating the container of FIG. 1.

### DETAILED DESCRIPTION

In the following detailed description, reference is made to accompanying drawings, which form a part of the detailed description. It will be readily understood that the aspects of the present disclosure, as generally described herein and illustrated in the drawings may be arranged, substituted, combined, separated and designed in a wide variety of different configurations, all of which are contemplated in this disclosure.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, a limited number of the example methods and materials are described herein.

In general terms, the container 10 shown in the Figures comprises a lower member 12 and a pair of upper members 14, with the lower member 12 and upper members 14. The upper members 14 are attached to the lower member 12, and are moveable between an open position for receiving the vessel 16 into the container 10 and a closed position in which the upper members 14 cooperate together and directly interlock with the lower member 12 to close the container 16. Accordingly, it is understood that with the vessel 16 being encased therein, the container 10 forms a protective housing that insulates the vessel 16 from shock and exposure during handling and transport.

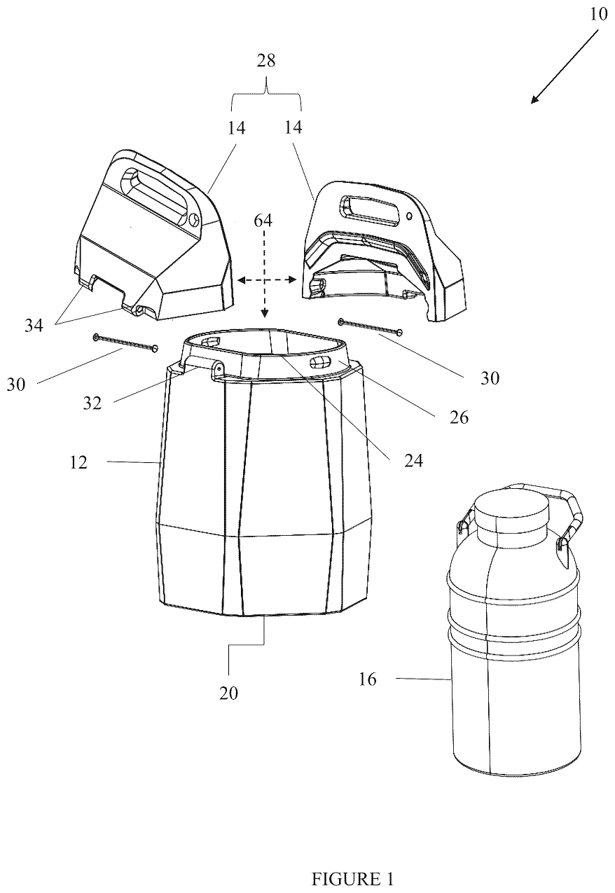

With reference to FIG. 1, the container 10 is particularly suitable for the transport of cryogenic vessels, with the vessel 16 shown in the Figure being representative of a cylindrical storage tank or “Dewar” typically used within the medical and veterinarian industries for the storage of biological matter at cryogenic temperatures. To avoid problems with cold embrittlement, such cryogenic storage tanks 16 are typically made from metallic materials including stainless steel, aluminium, brass, copper and alloys thereof.

The lower member 12 provides a main body of the container 10, having an inner chamber 18 for accommodating at least part of the vessel 16 therein. A flat base 20 provides a bottom about which the container 10 rests, with the lower member having an outer surface that extends about a generally vertical axis. The chamber 18 is preferably lined with a plurality of insulating members 22 (not shown). The insulating members may take the form of elongate foam pads, extending substantially vertically along a height of the chamber 18. The insulating members 18 serve to insulate the vessel 16 from shock and vibration during transport. Optionally, the pads 18 may also be made of a material having a low thermal conductivity, to reduce heat transfer to the vessel 16 from the outside. It is also contemplated that the insulating members 22 may be removeable members, such that a set of such members 22 may be selected to conform with the size and/or geometry of the vessel 16 therein. In this way, the container 10 is suitable for the transport of several different sized and/or shaped vessels 16. An opening 24 is provided towards the top of the lower member 12 and provides passage for the vessel 16 to be received therethrough. With particular reference to the embodiment shown in the Figure, the opening 24 is defined by an upstanding annular rim 26.

The upper members 14 are configured to cooperate together to provide a lid 28 of the container 10, with each upper member forming a segment thereof. Whilst the illustrated embodiment shows two upper members 14—with each upper member forming a half segment of the lid 28—other arrangements are also contemplated, in which each member 14 forms a part segment of the lid 28. The upper members 14 are hingedly attached to the lower member 12 via pins 30. In this way, the upper members 14 are pivotable about a generally horizontal axis of the lower member 12. It is understood, however, that the upper members 14 may be moveably attached or otherwise coupled to the lower member 12 by other methods.

As shown in the Figure, the pins 30 are receivable within hinge elements of the lower and upper members 12, 14 respectively. As shown in the Figure, the hinge element of the lower member 12 comprises a spline 32. The spline 32 includes a bore through which the pin 30 is insertable. The spine 32 is receivable between a pair of lugs 34 of the upper member 34. Each lug 34 also includes a bore through which the pin 30 is insertable. Each of the hinge elements 32, 34 is integrally formed with the respective member 12, 14. In particular, each hinge element 32 is flush or recessed with respect to the outer surface of the member 12, 14—and therefore does not protrude outwardly therefrom. Further, it the lower member has a tapered profile, contracting inwardly along its height from the bottom to the top thereof. With the hinge elements 32 of the lower member 12 (and hence the hinge elements 34 of the upper member 14 aligned therewith) being provided generally proximate the opening 24 at the top of the lower member 12, it is therefore understood that said elements 32, 34 are disposed within the footprint of the container 10, protecting the elements from inadvertent contact damage.

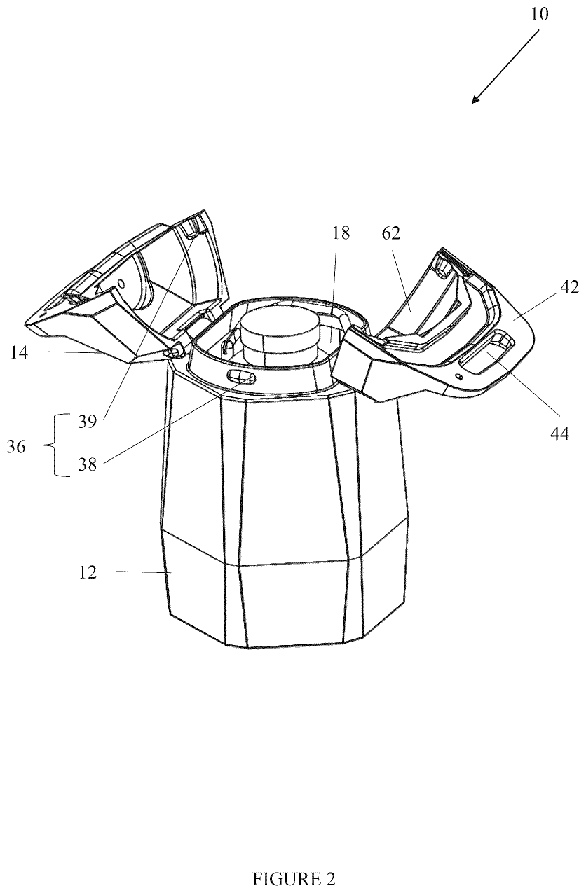

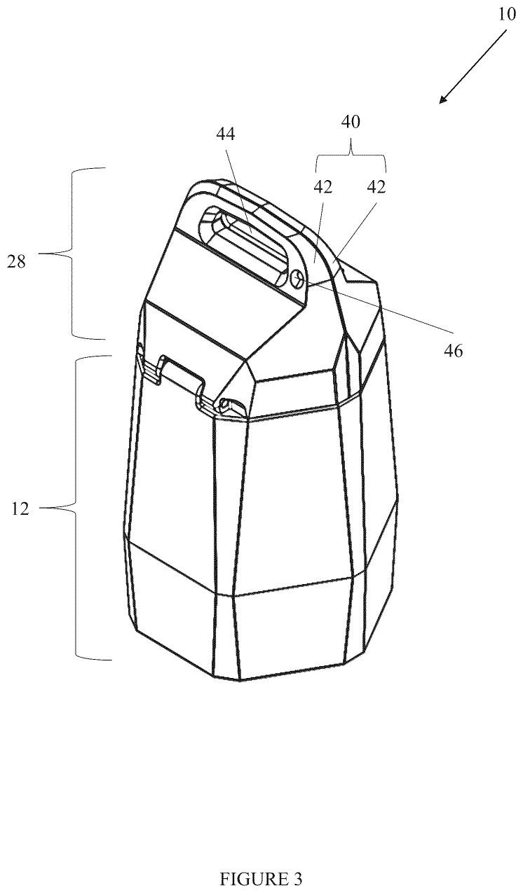

Each upper member 14 is moveable between an open position and a closed position. In the open position, the upper members 14 are separated to permit access to the opening 24. In the closed position, the upper members 14 co-operate together forming lid 28 that covers the opening 24. The position of the upper members 14 corresponds with different configurations of the container 10. In particular, when the upper members 14 are separated from one another in the open position, the container 10 is said to be in a first or loading configuration—as shown in FIG. 2. When the upper members 14 are in the closed position and cooperating to form lid 28, the container 10 is said to be in a second or transport configuration—as shown in FIGS. 3 to 7.

The lid 28 is configured to engage with and thereby interlock with the lower member 12. Best shown in FIG. 2, the lid 28 and lower member 12 include engagement elements that combine to form an internal detent 36. The detent 36 provides an integrated means for securing the lid 18 in position atop the lower member 12, thus obviating the need for separate clamping mechanisms. What is meant by an internal detent 36 is that, when the container 10 is in the transport configuration, the detent 36 lies within an interior thereof and therefore protected from external contact from neighbouring cargo during transport and/or inadvertent release during handling of the container 10.

In the embodiment shown, the engagement elements include a projection 38 that is received within a complementarily shaped slot 39 via a snap-fit. Accordingly, to provide the snap-fit, at least one of the engagement elements is resiliently deformable. It is understood, however, that other forms and/or arrangements of engagement elements are also contemplated. In particular, the lower member 12 includes an oval-shaped projection 38 that protrudes outwardly from the rim 26, whilst each upper member 14 includes an open-ended slot 39. The projection 38 and slots 39 are integrally formed with the respective member 12, 14. The slots 39 are arranged such that, when the upper members 14 are in the closed position, the respective slots 39 align and co-operate together to provide one continuous slot within which the projection 38 is captured. Moreover, because the projection 38 simultaneously engages with the slot 39 of each upper member 14, it is understood that this arrangement also serves as a locating means, to ensure correct positioning of the upper members 14 with respect to the lower member 12. In the illustrated embodiment, the lower member 12 includes two such projections 38, arranged on opposing sides of the rim 26, with the upper members 14 each having corresponding slots 39 on either side thereof. Whilst the projection 38 is shown as being oval shaped, with the slot 39 having a complementary elongate shape, it is understood that the engagement elements of the upper and lower member 14, 12 may take other forms and/or shapes.

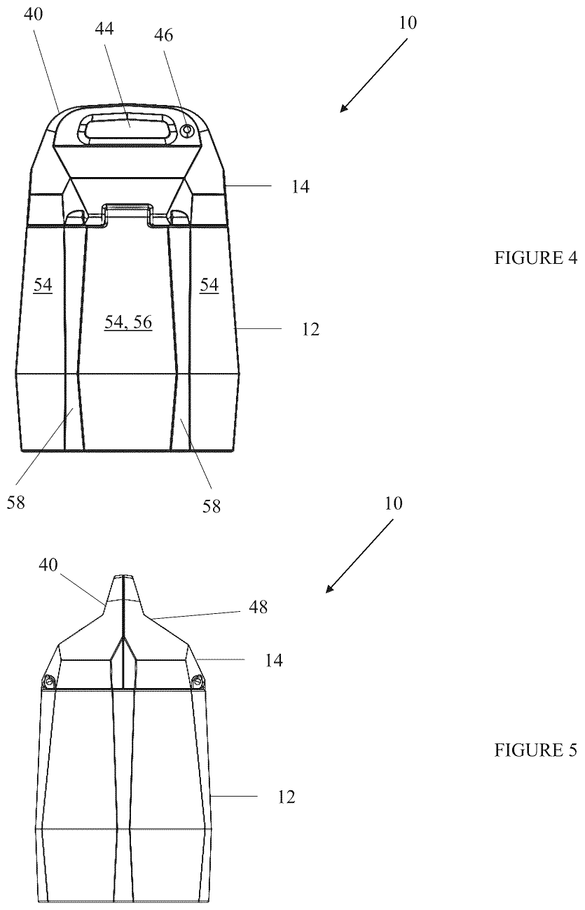

Turning now to FIGS. 3 and 4. The lid 28 includes a carry handle 40. The carry handle 40 is disposed along a centre line of the container 10 that substantially corresponds with a centre of gravity thereof, such that, when lifted therefrom, the container 10 is balanced and not prone to tipping or tilting. The carry handle 40 is integrally formed with the lid 28. Specifically, each upper member 14 includes a handle portion 42. In this way, the handle portions 42 of each upper member also serve as a handgrip by which the user may move the respective upper member 14 between the open and closed position. Notably, the carry handle 40 is designed to allow the container 10 to be lifted and carried or otherwise handled by one hand. Further, with the respective handle portions 42 being provided towards the inside of the upper member 14 and the hinge elements 34 being towards an outside, it is understood that the gripping action, by the user, upon the carry handle 40 imparts an inward torque thereupon, biasing the upper members 14 towards the closed position. This inward biasing of the upper members when the container 10 is being carried is beneficial, substantially obviating the need for an external clamp or otherwise to be applied to prevent inadvertent opening of the lid 28 when handled.

With respect to the illustrated embodiment, the handle portion 42 includes an upwardly extending arch shaped rigid arm that defines an aperture 44. When in the closed position, the a handle portions 42 of the abut together and apertures 44 align coaxially, allowing a user to lift and carry the container 10 therefrom—for example when loading and unloading the container 10 into a vehicle or cargo bay thereof for transport. It is also contemplated that each aperture 44 may instead be in the form of an indent such that carry handle 40 comprises two discrete, spaced apart grip portion 44, with said portions being symmetrically arranged about the centre line of the container 10 on opposing sides of the formed lid 28 and adapted to receive one or more fingers of a hand of the user.

Optionally, the arch shaped arms of each handle portion 42 may also include a hole 46. When in the closed position, the holes 46 of each upper member 14 align coaxially, being adapted to receive an anti-tampering member therethrough. The anti-tampering member may be in the form of a pad lock. The anti-tampering member may be used for preventing unauthorised and/or inadvertent opening of the container 10. Further, with the holes 46 being provided separate from the carry handle 40, it is noted that the fitment of the anti-tampering member does not affect the handleability of the container 10 by the carry handle 40.

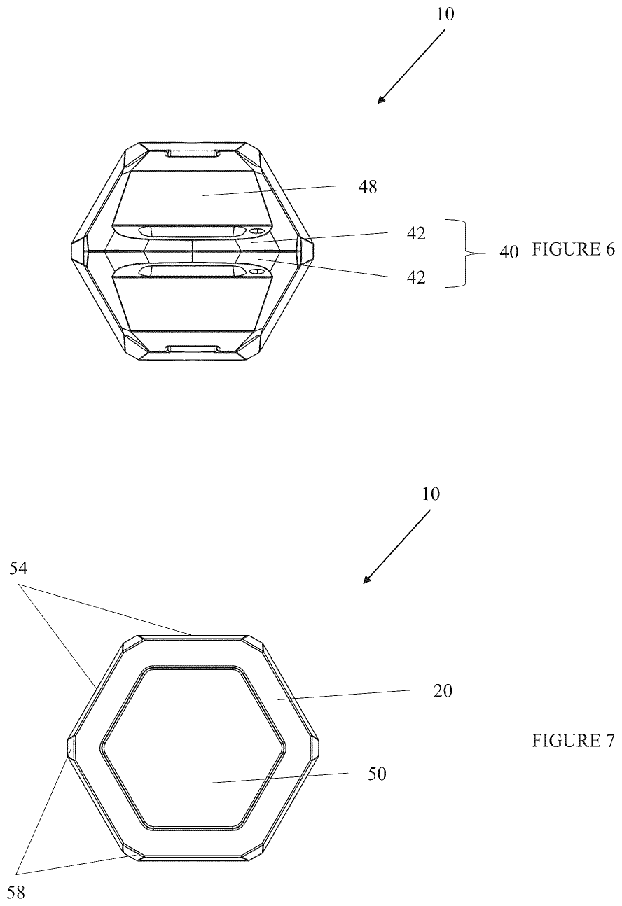

Best shown in FIGS. 5 and 6, the lid 28 has a downwardly inclined profile, with each of the upper members 14 having at least one ramped face 48. The ramped face(s) 48 serve to divert water and/or other liquids from pooling atop the container 10 during transport, thus deterring water ingress into the chamber 18 and enabling the container 10 to be transported and/or stored in exposed areas that are not covered and/or overly sheltered from the elements.

The base 20 of the container 10 is best shown in FIG. 7. As previously described, the base provides a generally flat resting surface about which the container is supported in an upright orientation. In the illustrated embodiment, the base 20 also includes a depression 50 which may be used to locate the container about a complementary shaped boss 52 (not shown) within a cargo space of a vehicle and/or storage area. Such a depression 50 may also serve to ensure the base 20 provides a flat resting surface when the containers 10 fabrication includes a polymeric manufacturing process, which without such depression 50 may result in doming and an uneven base 20. Accordingly, it is understood that the depression 50 may assist in retaining the container 10 in the upright orientation against inertial forces experienced during transport.

As shown in each of the preceding Figures (with labelling restricted to FIGS. 4 and 7 for clarity), the outer surface of the lower member 12 comprises a plurality of substantially planar faces 54 that are arranged about the vertical axis of the container 10. The planar faces 54 allow a plurality of containers 10 to be arranged together in a nested arrangement, where faces 54 of neighbouring (i.e. adjacent) containers may substantially abut against one another. At least one of the faces 54 may be a high friction surface 56. The high friction surface 56 may assist in preventing relative sliding of adjacent containers 10, thereby assisting in retaining a plurality of containers 10 in the nested arrangement during transport. Further, such a surface 56 may serve to hide both imperfections from the fabrication process, and damage from handling. The planar faces 54 of the lower member 12 are interspaced by a plurality of fillet faces or fillets 58. When arranged together in a nested arrangement, the fillets 56 of adjacent containers 10 define gaps or spaces between the neighbouring containers 10. The fillets 58 serve as a channel through which water or other liquids is directed away from the containers 10, thereby preventing or otherwise reducing the possibility of water ingress therein. The illustrated embodiment of the container 10 has a substantially hexagonal perimeter, which contributes to the aforementioned “nestability” of the containers 10. It is understood, however, that other orthogonal shapes are also contemplated.

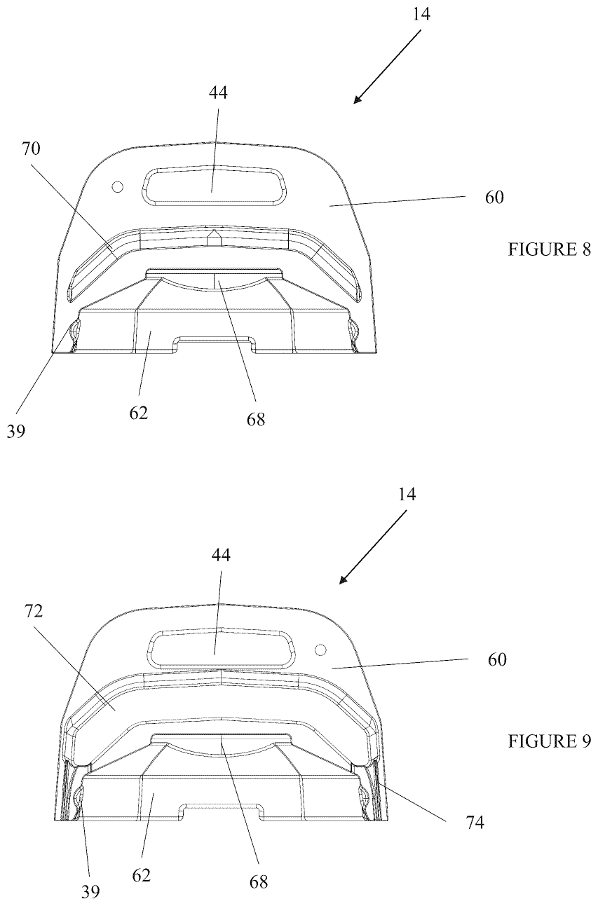

The interior geometry of the upper members 14 will now be described with reference to FIGS. 8 and 9.

The upper member 14 includes a generally planer inner surface 60. A recess 62 is disposed along a lower edge of the inner surface 60. When the container 10 is in the transport configuration, the respective inner surfaces 60 provide mating surfaces that substantially abut one another in a face-to-face arrangement, with the recesses 62 together forming a substantially hemispherical space 64 within which a portion of the vessel 16 may be accommodated. In particular, the space 64 and chamber 18 of the lower member 12 together provide a cavity 66 for accommodating the vessel 16, with the rim 26 being received and substantially located within the space 64 when the lid 28 is interlocked with the lower member 12. Furthermore, with the slots 39 of the respective upper members being disposed within the recess 62 and defining part thereof, when the lid 28 is interlocked with the lower member 12, the detent 36 is disposed inside the cavity 64. It is understood that by having at least a portion of the vessel 16 be receivable within the upper members 14, when said upper members 14 are positioned in the open position, at least a portion of the vessel 16 protrudes above the lower member 12. This improves access to the top of the vessel 16, making it easier to load the vessel 16 into and out of the container 10. With particular reference to the embodiment shown, an upper portion of each recess includes a seat 68 for receiving a disc shaped insulating member 22.

As previously outlined, the upper members 14 co-operate to form lid 28. What is meant by this, at least in part, is that each upper member 14 includes features that locate, align, or otherwise engage with one another when in the closed position. An example of such a feature is co-operating elements 70, 72. In particular, a first upper member (shown in FIG. 8) includes a projecting lip 70 that is receivable within a complementary shaped trough 72 of a second of the upper members (shown in FIG. 9). Together, the co-operating elements function as a guide, with the lip 70 having a draft angle that assists in bringing the upper members 14 into correct alignment with one another as the upper members 14 are closed inwardly together when moving into the closed position. Further, with the lip 70 being received and located within the recess 72, relative sideward (i.e. horizontal) movement of the upper members 14 is prevented or at least substantially constrained-such that the lid 28, when formed, is substantially rigid and free of flexure.

The co-operating elements 70, 72 are disposed upon/within the inner surface 60 of the respective upper members 14, between the recess 62 and the aperture 44 of the handle portion. In particular, the co-operating elements 70, 72 extend across and substantially around an upper periphery of the recess 62 to thereby form a barrier having a shape of an inverted U. With the lid 28 being coupled to the lower member 12, the barrier extends over the opening 24 acting as a guard that provides a mechanical seal across the cavity 66, diverting water away therefrom. In this way, water that may otherwise fall between the abutting faces 60 of the upper members 14 is directed away from the opening, and communicated along channels 74 of the second upper member 14 to the external surface thereof. The channels 74 are best shown in FIG. 9, being in fluid communication with the recess 62, and extending downwardly to the bottom of the upper member 14, to thereby feed water outwardly therefrom.

The applicant has identified that the provision of both a comparatively ‘small’ and a ‘large’ sized containers may be advantageous. Accordingly, it is understood that while container 10 as shown may have, for example, approximate dimensions of about 370 mm in width and about 660 mm in height, such sized container 10 being suitable for accommodating vessels 16 having a capacity of about 3.6 litres, the container 10 may be fabricated in other sizes suitable for different sized vessels 16.

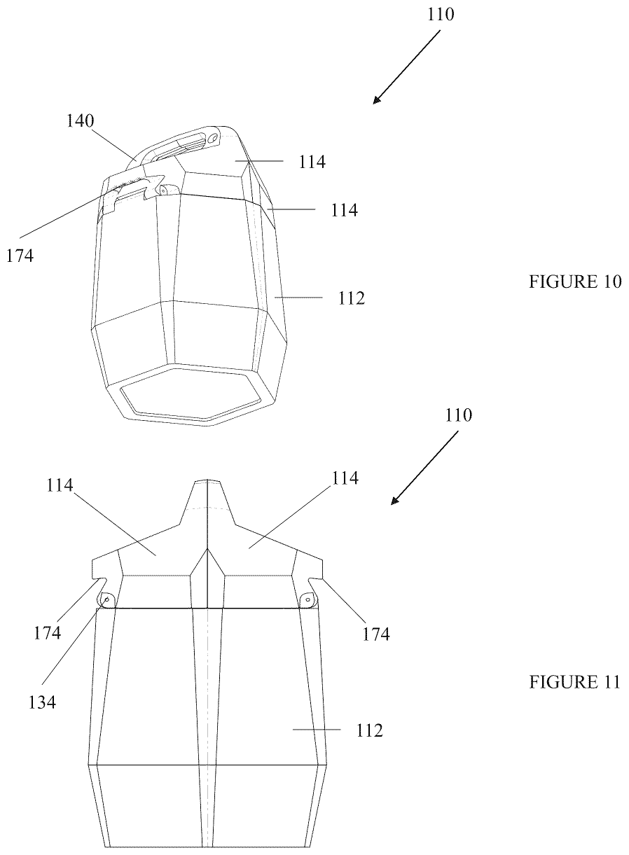

An alternative embodiment of the invention, in the form of container 110, will now be described with reference to FIGS. 10 and 11. For clarity, similar reference numerals will be used to describe similar components and/or functional analogues.

Container 110 is generally similar to container 10 previously described, with a distinction being that the container 110 includes additional pick-up portions 174. It is contemplated that the provision of pick-up portions 174 is particularly advantageous where the container 110 is a comparatively ‘large” container, suitable for the protection of vessels 116 that may be of larger capacity than the vessels 16 stored within container 10. In particular, it is understood that the container 110 may have, for example, approximate dimensions of about 580 mm in width and about 800 mm in height, such sized container 110 being suitable for accommodating vessels 116 of a capacity of about 36.5 litres. It is understood, however, the container 110 may be fabricated in other sizes suitable for different sized vessels 116.

The pick-up portions 174 are provided to assist in the lifting the container 110 when it is protecting a filled vessel 16, such as, for example, during loading into a shipping container, transport vehicle or the like. The pick-up portions 174 may, however, also be used to facilitate handling and/or carrying the container 110 when empty. As shown, the pick-up portions 174 are disposed on substantially opposite sides of the container 110 to. The arrangement of the pick-up portions 174 provides for two distinct methods of using said pick-up portions 174. Namely, a user can either bend over the container 110, and grip one of the pick-up portions 174 in each hand to then lift the container 110, or, alternatively, two users can grip a respective pick-up portion 174 each, and thereby share the weight thereof. As shown, the pick-up portions 174 are each provided in a form of a notch or depression. What is meant by this is that the pick-up portions 174 are provided by way of cavities or depressions within the upper members 14. During use, a user or users may insert their hand/fingers to securely grip the pick-up portions 174 and thus easily lift the container 110 (even when a large/heavy vessel 116 is accommodated therein). The notches may include finger shaped corrugations or other ergonomic elements to assist a user in gripping the pick-up portions 174.

Shown most clearly in FIG. 11, the pick-up portions 174 are preferably disposed atop respective upper members 114 of the container 110. Providing the pick-up portions 174 in this manner allows them to function in a similar manner to the carry handle 40 of container 10, in that, with the respective pick-up portions 174 being provided on or as part of the respective upper members 114, and with hinge elements 134 being towards an outside of the container 110, a lifting action via both pick-up portions 174 simultaneously will impart an inward torque that biases the upper members 114 towards the closed position.

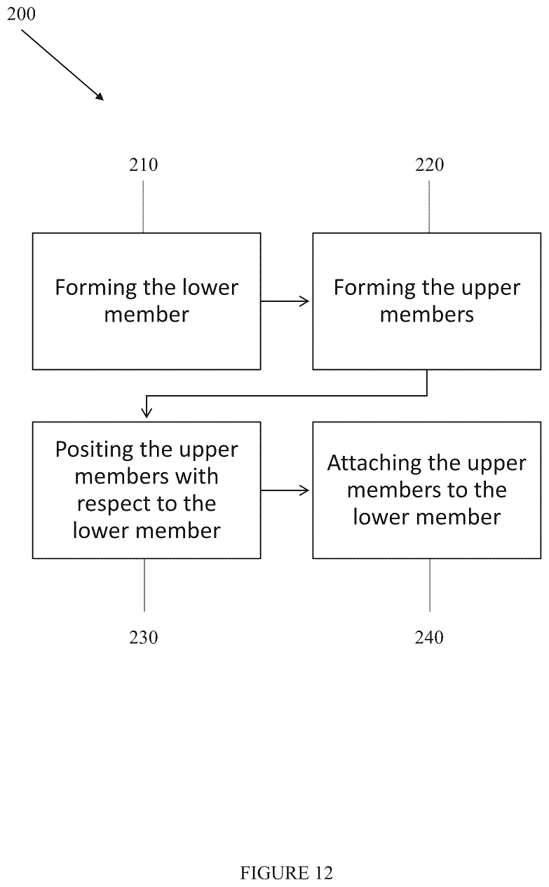

A method 200 of fabricating the container 10 as described herein will now be described, with particular reference to FIG. 12. While the method 200 is described hereunder in reference to the fabrication of container 10, it is understood that the method 200 may also be used to fabricate container 110 as described herein.

In a step 210, the lower member 12 is formed as a unitary body of polymeric material. Examples of suitable materials include polyurethane, polyethylene, polypropylene and hybrid compositions thereof. By making the lower member 12 from a polymeric material, the lower member 12 is comparatively lightweight (compared to metallic materials) while retaining the necessary durability and impact resistance to protect the vessel 16 during transport. With respect to the illustrated embodiment, the lower member 12 is formed via a rotational moulding process. It is understood, however, that the lower member 12 may be formed by other moulding processes such as blow moulding and/or injection moulding.

In a further step 220, the upper members 14 are formed as unitary bodies of polymeric material. Preferably, the upper members 14 are formed of the same material as the lower member 12. In this way, with body the upper members 14 and lower member 12 have at least some degree of resilience/flexibility, allowing for the snap-fit interlocking of said members. Like the lower member 12, the upper members 14 are formed via an rotational moulding process; however, other moulding processes are also contemplated. It is noted that the upper members 14 may be formed simultaneously with the lower member 12. Alternatively and/or additionally, more than one lower member 12 may be formed simultaneously in a single mould.

In a following step 230, the upper members 14 are moved into position with respect to the lower member 12, with the lugs 34 bookending the spline 32 of the lower member, with the bores thereof being coaxially aligned. In this way, it is noted that the complementary geometries of the lugs 34 and spline 32 assist in locating each upper member 14 in correct position with respect to the lower member 12, awaiting attachment thereto. It is noted that this step may be automated, with the use of robotic arms or similar. Furthermore, it is possible for the upper and/or lower members 14, 12 to be moved into position directly after the moulding operation of steps 110,120, for example with a robotic arm being used to de-mould the respective member and then move it into the desired position.

In a further step 240, pins 30 are inserted through the bores of the hinge elements 32, 34. This step is preferably undertaken in conjunction with the earlier step 130, however may also constitute a separate operation. At the completion of this step 140, with both upper members 14 now being attached to the lower member 12, the container 10 is fully assembled and ready for use.

Summarily, it is to be understood that the transport containers as described herein provides several performance advantages and manufacturability improvements over existing designs. For example, the direct interlocking of the lid with the lower member via the integrally formed detent obviates the need for a separate, distinct, securing means to be provided, thereby reducing the number of operations required to fabricate the container. Further, with the detent being disposed within the container itself, the possibility of inadvertent opening of the container is reduced. In addition, the co-operation of elements of the upper members when forming lid provides a mechanical seal over the cavity, serving as a barrier that directs water away from the container, protecting the contents therein.

The reference in this specification to any prior publication (or information derived from it), or to any matter which is known, is not, and should not be taken as an acknowledgment or admission or any form of suggestion that that prior publication (or information derived from it) or known matter forms part of the common general knowledge in the field of endeavour to which this specification relates.

Throughout this specification and the claims which follow, unless the context requires otherwise, the word ‘comprise’, and variations such as ‘comprises’ and ‘comprising’, will be understood to imply the inclusion of a stated integer or step or group of integers or steps but not the exclusion of any other integer or step or group of integers or steps.

LEGEND

| | |
|---|---|
| 10 | Container |
| 12 | Lower Member |
| 14 | Upper Member |
| 16 | Vessel |
| 18 | Chamber |
| 20 | Base |
| 22 | Insulating Member |
| 24 | Opening |
| 26 | Rim |
| 28 | Lid |
| 30 | Pin |
| 32 | Spline |
| 34 | Lug |
| 36 | Detent |
| 38 | Projection |
| 39 | Slot |
| 40 | Carry Handle |
| 42 | Handle Portion |
| 44 | Aperture |
| 46 | Hole |
| 48 | Ramped face |
| 50 | Depression |
| 52 | Boss |
| 54 | Planar Face |
| 56 | High Friction Face |
| 58 | Fillet |
| 60 | Inner Surface |
| 62 | Recess |
| 64 | Space |
| 66 | Cavity |
| 68 | Seat |
| 70 | Lip |
| 72 | Trough |
| 110 | Container |
| 174 | Pick-up portion |
| 200 | Method |
| 210 | Forming Step - Lower Member |
| 220 | Forming Step - Upper Member |
| 230 | Positioning Step |
| 240 | Attaching Step |

1. A transport container for a cryogenic vessel, comprising a lower member and two upper members that are attached thereto, the lower and upper members together defining a cavity for accommodating the vessel therein, with the upper members being moveable between an open position and a closed position, wherein, in the closed position, the upper members cooperate to form a lid that interlocks with the lower member to close the cavity.

2. The container of claim 1, wherein the lower member and each upper member include engagement elements that, when the upper members are in the closed position, form an internal detent that secures the upper members in the closed position.

3. The container of claim 2, wherein the engagement element of the lower member comprises a projection that is configured to seat within a slot of each of the upper members in a snap-fit.

4. The container of claim 1, wherein the upper members include cooperating elements that guide and locate the upper members into the closed position.

5. The container of claim 4, wherein, when the upper members are in the closed position, the cooperating elements form a barrier that extends across an opening of the cavity and directs water away therefrom.

6. The container of claim 4, wherein the cooperating elements comprise a lip that projects from an inner surface of a first of the upper members and a trough within an inner surface of a second of the upper members, with the lip being receivable within the trough.

7. The container of claim 1, wherein, in the closed position, the upper members together form a carry handle of the container.

8. The container of claim 7, wherein, when the container is carried by the handle, the upper members are biased towards the closed position.

9. The container of claim 7, wherein each upper member includes an upwardly extending handle portion for moving the upper members between the open and closed positions, the handle portions abutting in the closed position of the upper members to form the carry handle.

10. The container of claim 9, wherein each handle portion includes an hole for receiving an anti-tampering member therethrough to prevent unauthorised and/or inadvertent movement of the upper members from the closed position, the hole being spaced from a grip portion of the handle.

11. The container of claim 1, wherein the upper members are hingedly attached to the lower member, with the upper members and the lower member having integrated hinge elements.

12. The container of claim 11, wherein the lower member has a tapered profile, with the hinge elements being disposed within a footprint thereof.

13. The container of claim 1, wherein an outer surface of the lower member is adapted to allow a plurality of containers to be arranged together in a nested arrangement.

14. The container of claim 13, wherein the outer surface of the lower member is adapted such that, in the nested arrangement, a plurality of defined gaps are formed between abutting containers.

15. The container of claim 14, wherein the outer surface of the lower member comprises a plurality of substantially planar faces arranged around a vertical perimeter thereof, with the plurality of gaps between abutting containers being defined by fillets disposed between adjacent faces of the respective containers.

16. The container of claim 1, further comprising insulating members mounted within the cavity to protect the vessel therein.

17. The container of claim 1, wherein the lower member and each upper member is formed, respectively, as a unitary body.

18. The container of claim 1, wherein the lower member and each upper member is formed of a polymeric material.

19. The container according to claim 1, further including a pair of pick-up portions that are disposed on opposing sides of the container.

20. (canceled)

21. A method of fabricating a transport container for a cryogenic vessel, comprising a lower member and two upper members that are attached thereto, the lower and upper members together defining a cavity for accommodating the vessel therein, with the upper members being moveable between an open position and a closed position, wherein, in the closed position, the upper members cooperate to form a lid that interlocks with the lower member to close the cavity, the method comprising the steps of:
forming each of the lower and upper members via a moulding process; and
attaching each upper member to the lower member by a pin that is insertable through hinge elements of the respective upper member and the lower member.
